(19) United States
(12) Patent Application Publication
(10) Pub. No.: US 2025/0041733 A1
(43) Pub. Date: Feb. 6, 2025

(54) MODIFYING GAMEPLAY EXPERIENCES

(71) Applicant: SONY INTERACTIVE ENTERTAINMENT LLC, San Mateo, CA (US)

(72) Inventors: Lachmin Singh, San Mateo, CA (US); Yayoi Ukai, San Mateo, CA (US); Jasmine Amerson, San Mateo, CA (US); Sarah Karp, San Mateo, CA (US)

(21) Appl. No.: 18/230,031

(22) Filed: Aug. 3, 2023

(51) Int. Cl. A63F 13/67; A63F 13/5375; A63F 13/54; A63F 13/79

(52) U.S. Cl. CPC A63F 13/67; A63F 13/5375; A63F 13/54; A63F 13/79

(57) ABSTRACT

A system and method for providing a customized in-game audio experience is disclosed. One or more media files that includes one or more different profiles are received by the system. The media files are analyzed to identify one or more characteristics associated with each of the profiles. One or more parameters associated with an object in the virtual environment are modified based on a characteristic of a profile during an interaction with a user.

### BACKGROUND OF THE INVENTION

### 1. Field of the Invention

The present system generally relates to providing a customized in-game experiences. More specifically, the present system relates to modifying in-game audiovisuals in a manner specific to a user of an entertainment device.

### 2. Description of the Related Art

Interactive experiences in video games and other interactive content titles may offer a wide variety of options relating to virtual environments, characters, objects, abilities, and actions. With increased hardware and software capabilities, modern games may utilize a vast quantity of different available environments, characters, and other storytelling devices to engage with a player. Such engagement and storyline progression may be driven by a player interacting with in-game objects that are controlled by code, such as a non-player character (NPC) that may act as an ally, an enemy, or in some other capacity where the interaction allows the experience to evolve or further the plot. Unlike player characters whose actions and dialogue are controlled by a player, NPC behaviors are generally based on game code and may therefore be predetermined in accordance with the game code. Similarly, other in-game objects, such as virtual weapons, tools, toys, vehicles, and other virtual items, may likewise be controlled by associated game code to appear, sound, and interact within the virtual environment in predefined ways.

Engagement with an NPC or other object within a virtual environment of an interactive title during a session generally involves communication such as text-based or verbal exchanges, as well as in-game actions or behaviors (e.g., fighting, sparring, racing, competing or collaborating in other contests or challenges). Depending on theme or genre of the specific interactive content title, conversation between a player and an NPC may not only be functional (e.g., educational, mission- or goal-oriented), but can also range from trivial or humorous to heartfelt or dire. High-quality in-game animations, voice acting, and writing may be used to immerse the player in the virtual interaction with the objective of deepening the player's engagement and active participation in the virtual world. Providing the player with various options for how such interactions take place further emphasizes the impact and influence that the player has over the story and characters.

Engagement with an NPC within a virtual environment of an interactive title during a session generally involves communication such as text-based or verbal exchanges, as well as in-game actions or behaviors (e.g., fighting, sparring, racing, competing or collaborating in other contests or challenges). Depending on theme or genre of the specific interactive content title, conversation between a player and an NPC may not only be functional (e.g., educational, mission- or goal-oriented), but can also range from trivial or humorous to heartfelt or dire. High-quality in-game animations, voice acting, and writing may be used to immerse the player in the virtual interaction with the objective of deepening the player's engagement and active participation in the virtual world. Providing the player with various options for how such interactions take place further emphasizes the impact and influence that the player has over the story and characters. Notwithstanding, presently available virtual interactions between the player and NPC are still based on a predefined set of dialogue and recorded voice acting.

There is a need in the art for improved systems and methods of creating personalized gameplay experiences based on modifications to gameplay audiovisual content.

### SUMMARY OF THE CLAIMED INVENTION

Embodiments of the present invention include methods for providing a customized in-game audio experience. The methods include receiving one or more media files that includes one or more different profiles, analyzing the media files to identify one or more characteristics associated with each of the profiles, and modifying one or more parameters associated with an object in the virtual environment based on a characteristic of a profile during an interaction with a user.

Embodiments of the present invention include systems for providing a customized in-game audio experience. The system includes a memory; a communication interface that may receive data sent over a communication network regarding one or more media files to identify one or more characteristics associated with each of the profiles; a processor that executes instructions stored in memory that may analyze the media files to identify one or more characteristics associated with each of the profiles and modify one or more parameters of an object in the virtual environment based on a characteristic of a profile during an interaction with a user.

Embodiments of the present invention also include a non-transitory computer-readable storage medium having embodied thereon a program, the program being executable by a processor to perform a method for providing a customized in-game audio experience. The methods include receiving one or more media files that includes one or more different profiles, analyzing the media files to identify one or more characteristics associated with each of the profiles, and modifying one or more parameters associated with an object in the virtual environment based on a characteristic of a profile during an interaction with a user.

### BRIEF DESCRIPTION OF THE DRAWINGS

FIG. 1 illustrates an exemplary network environment in which a system for modifying gameplay experience may be implemented.

FIG. 2 is a flowchart illustrating an exemplary method for modifying gameplay experience.

FIG. 3 illustrates a block diagram of an exemplary electronic entertainment system.

FIG. 4 illustrates a block diagram of an exemplary device.

FIG. 5 is a flowchart illustrating an exemplary method for modifying gameplay experiences related to voice.

FIG. 6 is a flowchart illustrating an exemplary method for modifying gameplay experiences related to sound or music.

FIG. 7 is a flowchart illustrating an exemplary method for modifying gameplay experiences related to game tutorials.

### DETAILED DESCRIPTION

Embodiments of the present invention therefore include systems and methods for providing a customized in-game audiovisual experience. One or more media files that includes one or more different profiles are received by the system. The media files are analyzed to identify one or more characteristics associated with each of the profiles. One or more parameters associated with an object in the virtual environment are modified based on a characteristic of a profile during an interaction with a user. As discussed herein, the modified object may include NPCs, as well as other types of in-game or virtual objects, environments, and experiences. Modifying object characteristics (e.g., character voices and appearances to look and sound like a friend or favorite characters of a user) would allow the user to experience a more intimate and personalized gaming experience and encourage continued engagement with the game.

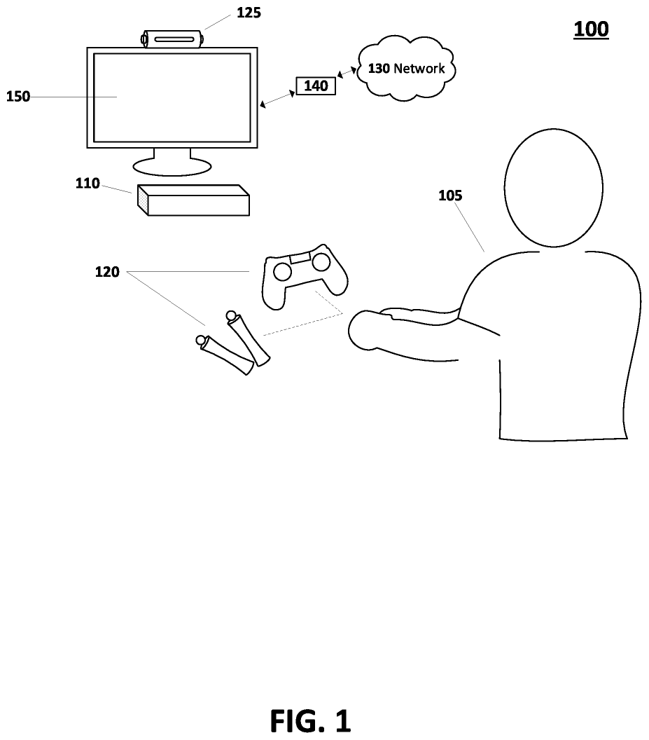

FIG. 1 illustrates a schematic diagram of an exemplary entertainment environment 100. As shown, the entertainment environment 100 may include equipment such as a console 110, controller(s) 120, one or more sensors, and/or a display. The entertainment environment 100 includes various devices, components, sub-components, hardware/software, interfaces, and the like, which collectively operate form an entertainment system that provides an immersive and interactive simulated experience to a user 105.

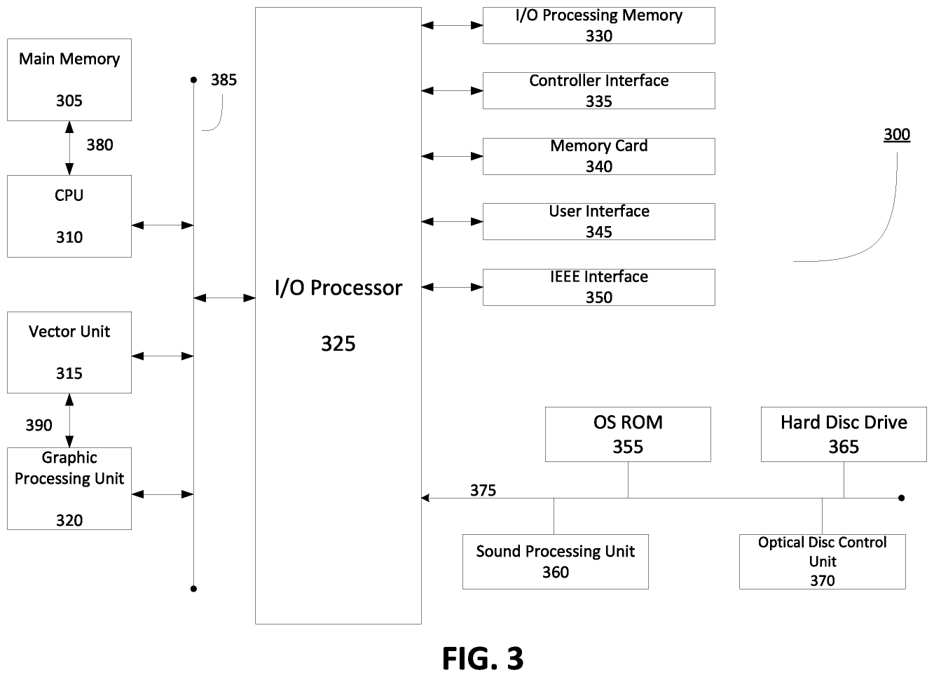

Console 110 represents centralized hardware and software that allow for communication with controller 120 and/or sensor 125, as well as communicates with various other devices, servers, databases, and the like over a communication network 130 (e.g., local area network, wide area network, the Internet), as is appreciated by those skilled in the art. In various embodiments, console 110 executes the instructions in accordance with a particular game title to establish and support a gameplay session, as well as provide associated services to user 105. Console 110 may include a user device and components thereof described in further detail with respect to FIG. 3.

Controller 120 wirelessly communicates with console 110 over network 130, or (in some embodiments) it may be coupled to console 110 over another network (not shown). Controller 120 may include a virtual reality headset. Controller 120 facilitates user interaction with and within the networked environment 100 and is operable to, for example, detect, track, or otherwise monitor movement and biometric information, communicate data signals with sensor 125 and console 110, and provide feedback (e.g., tactile, audible, etc.) to a user 105. In this fashion, controller 120 can include any number of sensors, gyros, radios, processors, touch detectors, transmitters, receivers, feedback circuitry, and the like.

Sensors 125 may wirelessly communicate with console 110. Sensors 125 may track eye movements, appearance of the user, body movements, facial expressions, sounds and voice outputs from the user, and measure biometric data from user 105. Sensors 125 may include one or more cameras, microphones, accelerometers, gyroscopes, haptic feedback sensors, and other types of sensors 125 configured to monitor a real-world space in which a player may be interacting with an entertainment system. As such, the sensors 125 may be placed or located at various locations within the space, including locations in proximity to or embedded in the other devices or in proximity to or worn by the player.

Communication network 130 represents a network of devices/nodes interconnected over network interfaces/links/segments/etc. and operable to exchange data such as a data packet 140 and transport data to/from end devices/nodes (e.g., console 110, controller 120, and/or sensor 125).

Data packets 140 include network traffic/messages which are exchanged between devices over communication network 130 using predefined network communication protocols such as certain known wired protocols, wireless protocols (e.g., IEEE 802.11, WiFi, Bluetooth®, etc.), PLC protocols, or other shared-media protocols where appropriate.

Display 150 may display or project simulated graphical elements that form simulated environments to user 105. Display 150 may include a monitor, television, projection screens, another device screen, virtual reality headset, virtual reality projection systems, etc. Display 150 may display information provided from console 110, controller 120, sensor 125, and other data received via the network 130 from cloud servers, game servers, remote user devices associated with other players, and other remote devices. With respect to the devices discussed above, it is appreciated that certain devices may be adapted to include (or exclude) certain functionality and that the components shown are shown for purposes of discussion, not limitation.

In exemplary implementations, console 110 may be used by user 105 to initiate and engage in an interactive session in relation to an interactive content title, such as a game title. Such interactive session may include gameplay with other user devices (e.g., other consoles 110) of other (remote) users over communication network 130, as well as facilitated by content host servers and/or other service providers over communication network 130. Where an interactive content title includes a storyline driven by one or more NPCs or other virtual objects, each of the NPCs or virtual objects may be tailored to the specific user 105.

Where the user 105 may be a new player, the attributes of user 105 may initially be unknown. A user profile may be built for the user, however, based on historical and current activities that may be monitored by console 110 and associated devices. For example, some content titles may involve a registration, character or object creation, or other initialization processes during which user preferences may be requested or discerned. The feedback from the user—which may include not only express answers, but also associated non-verbal selections, behaviors, reaction data, etc., that may be observed by sensors 125—may be stored in an associated user profile. In addition, various analytical techniques—such as image analyses, text analyses, voice analyses, gesture analyses, game behavior analyses—may be applied to the user profile to identify and classify sets of data indicative of particular user attributes. Social and interpersonal interactions may also be tracked by console 110 in relation to social networks and platforms and sessions, social subscriptions, fandom indicators, associated services (e.g., that maintain user-specific music playlists, favorite content lists) in-game interactions with other players, and associated demographic or profile data for the other players. Social or interpersonal interaction data may also provide a basis for extrapolating and classifying player attributes.

As the user 105 engages with interactive content, other players, and associated content services via console 110, additional data regarding user behaviors may be monitored and added to the user profile for use in modeling tailored audiovisual experiences in virtual environments. As such, the user profile may be continually updated with new user data, which may be used to refine pattern recognition and predictions by learning models associated with the user, including learning models trained to identify audiovisual modifications predicted to result in making an interactive experience more engaging to the user.

A learning model may be used to characterize the player attributes based on known language, regional dialects or accents, commonly-used turns of phrase, voice tones, gestures, and behaviors. Such model may be updated based on new characterization of language, gestures, and behaviors based on user feedback. The model may further utilize dictionary definitions, known tone words, previously defined player attributes from other games, or attributes as identified by or based on feedback from other players. Where content preferences are being analyzed, the model may further apply pattern recognition to user-associated playlists or favorite lists to identify common characteristics and to predict which characteristics may be correlated with higher user engagement.

In addition, a player attribute may include sentiments and expressions thereof. For example, positive language such as “pretty” may indicate admiration. An excited tone of voice and speech that includes such phrases as “wow!” or “cool beans!” or actions may indicate enthusiasm, along with certain behaviors like jumping up and down, dancing, or other bodily movements. In another example, actions that skip dialogues or long text may be associated with impatient player attribute. In another example, the gestures of throwing hands up in the air, the sound of sighing, frowning may indicate an attribute of being annoyed.

Machine learning techniques (e.g., similar to those used by large language models trained using large data corpora to learn patterns and make predictions with complex data) may further be applied to train a model based on user data, including game data, which may be captured during gameplay sessions of the same or different users and user devices. Such game data may include not only information regarding the game and other content titles being played, but also user profiles, chat communications (e.g., text, audio, video), captured speech or verbalizations, behavioral data, in-game actions, etc., associated with the gameplay session. In some implementations, other content titles associated with the user (e.g., music playlists, favorite books, movies, etc.) may be received from or otherwise discerned in relation to the user, social circles, or service providers, as well as used as bases for modifications to a current interactive session. In addition, game data may be monitored and stored in memory as object or activity files, which may be used for supervised and unsupervised learning whereby a model may be trained to recognize patterns between certain game/user data and associated user attributes, as well as to predict customizations that would tailor an NPC or other in-game object or experience to be suitable for a particular user. In some implementations, sets of the object files or activity files may be labeled in accordance with any combination of game metadata and user feedback during or in association with gameplay sessions.

User feedback may indicate certain preferences or ways in which the NPC/object (e.g., appearance, manner of speech, behaviors, roles, and other ways in which they drive the storyline) may be further tailored to the liking of the user. Such user feedback may be used not only to tailor subsequent in-game interactions for sessions with the specific user, but also for sessions with users identified as sharing similar user attributes. In that regard, the learning model may not only be constructed for or customized to a particular user, but may be used for user groups that share similarities. Further, the system may affirm such associations or patterns by querying a player for feedback on whether the NPC/object was likable, interesting, or seemed rude and utilize the user feedback to further update and refine the model, as well as monitoring associated or concurrent chat communications and sensor data regarding the user 105 to discern positive or negative reactions.

The machine learning model may thus be trained to process natural language communications (e.g., such as verbal, textual, etc.) in conjunction with available user data to identify in-game modifications to one or more virtual object or environmental characteristics utilizing input or feedback from the user, user characteristics, prior modifications, one or more parameters for the game title, data pertaining to one or more additional users, databases, etc. The identified modifications may thereafter be applied to virtual characteristics of the in-game object, which may then be re-rendered and executed in a current or subsequent gameplay or interactive session. Different machine learning models may be trained using different types of data input, which may be specific to the user, the user demographic, associated game or other interactive content title(s) and genres thereof, social contacts, etc. Using the selected data inputs, therefore, the machine learning model may be trained to identify attributes of a specific user and identify customization parameters that may be specifically relevant to the requesting user (e.g., female 10-year old child that plays dancing games with pop music playlists, male 57-year old adult that plays racing games with country music playlists, male 31-year old adult that plays horror-based games with heavy metal playlists).

Identified user attributes may be associated with a different pattern of in-game engagement and in-game customization. A pattern of certain positive actions or reactions towards a character/object may reinforce associations with certain content modifications, and conversely, negative actions or reactions may be strongly associated with other types of content modifications. For example, certain songs or types of songs played during certain game sequences may be strongly correlated with happy or excited reactions and improved gameplay. Similarly, certain character modifications (e.g., to mirror user speech patterns) may be correlated with increased user interest and prolonged engagement as indicated by user speech and behaviors (real-world and in-game/virtual).

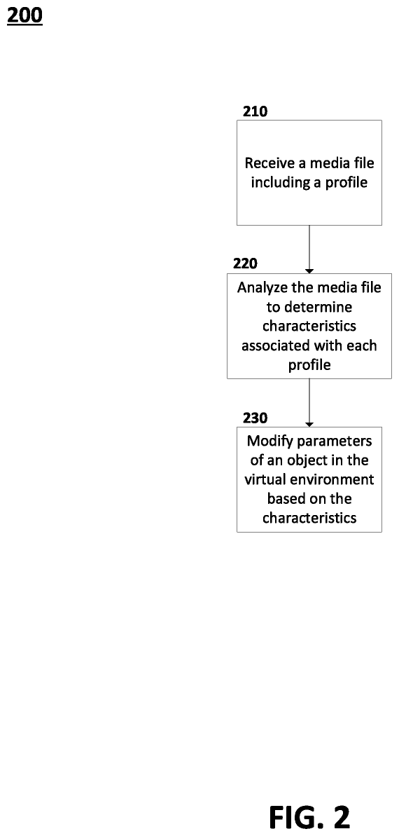

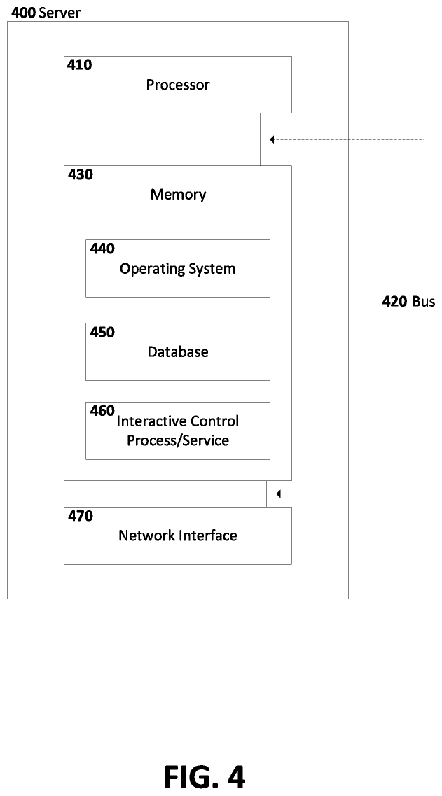

FIG. 2 is a flowchart illustrating an exemplary method 200 for tailoring in-game dialogue. The method 200 may be carried out by the system 100 in FIG. 1, system 300 in FIG. 3 or system 400 in FIG. 4. The method 200 begins at step 210, in which the system receives one or more media files that includes one or more different profiles. The media files may be audio files that include one or more different voice profiles or music profiles. Each profile may belong to a voice of a different person. If more than one profiles are received, the system may allow the user to select one of the profiles to be used for subsequent analysis or for modification of an object.

The media files may be video or image files, for example, a visual data that includes appearance of the user (or associated avatar in virtual environment) or body and facial movement of the user (or associated avatar) using the entertainment system. Media files may therefore include any audiovisual content captured and recorded during an interactive session, including both content corresponding to audiovisual displays of the virtual environment (e.g., virtual environment and associated avatar(s)) and content corresponding to audiovisual displays of the real-world environment (e.g., surrounding the user).

The media files may further be inclusive of activity files that track in-game or virtual activities of a player within a virtual environment while engaging with a content title via an entertainment system or connected to a gaming server. The activities of the player may include in-game activities of a user, a peer of the user, or a famous player, etc., as well as other concurrent activities (e.g., chat session, real-world behaviors). As such, the activity files may be data captured within the virtual game as well as in the real world during a game session. The activity file may include detected in-game objects, entities, activities, events, etc., that players have engaged with, or button presses that a player has made during an in-game scene or an event.

The media files may be provided by the user, downloaded over the network, received passively or automatically from one or more sensors, the entertainment console, a gaming server, or any other device connected to the network or intra network connected to the system 100. For example, the media files may be received by passively recording a chat conversation between the user of the system 100 and another user connected via a network. In another example, the media file may be songs from a custom playlist of a user or a favorites folder stored in a user computer.

At step 220, the media files may be analyzed to determine one or more characteristics associated with each of the profiles. For an audio media file such as a voice file, the characteristics may include various acoustic features such as pitch, loudness, style, register, accent, intonation, speed/pacing, or prosody extracted from the vocal waveforms. Various parameters of speech may be extracted from the audio media file to determine the characteristics of the voice file. A voice file may be transcribed into a text to train a text to speech model for generating a vocal waveform with the characteristics found in the voice file. For a sound or music file, the characteristics may include timbre, loudness, tempo, rhythm, melody, structure such as beat division, amount of rubato, or articulation (amount of connection between successive notes). For example, for music with light timbre, slower tempo, legato articulation, quiet, with fewer beats per measure would be characterized as serene or relaxed. In another example, music with faster tempo, even and tight rhythm, loud dynamics with obvious contrasts, sharper timbre, 8 or more beats per measure would be characterized as bright character. The definition to the characteristics may be stored in memory. Different portions of a media file may be characterized differently based on the identified parameters of each of the profiles. For example, one song could begin quietly, have somber characteristic in the middle but end with an upbeat characteristic.

The characteristics of an in-game scene in the virtual environment may also be analyzed. Various parameters of an in-game scene, such as movement of the in-game objects, lighting, color, in-game level and location, in-game progress such as clearing a stage, presence or appearance of certain in-game characters or objects, tone of an in-game dialogue, or any metadata associated with defining the in-game scene may contribute to characterization of the in-game scene. For example, an in-game scene containing leaves falling slowly in the background, slow moving in-game characters during a sunset lighting in between

The analyzed characteristics in the media file or a portion of the media file may be compared to and/or matched with a characteristic of an in-game scene. For example, a portion of the music file characterized as serene may be matched with an in-game scene characterized as serene. Similar words to serene, such as calm, quiet, peaceful, tranquil, content, smooth, etc., can also be used to classify and otherwise match to the defined serene characteristic.

The media file containing activity files may be analyzed based on the type and characteristics of the activity. The activity may include a button input sequence from a user or a remote user for an in-game activity. The analysis on the media file may include mapping the button input sequence. An analyzed activity profile may be compared to another activity profile. For example, the button input sequence of a well-known user received in the activity file may be compared in real-time to button input sequence of a user currently engaged in the same in-game activity in the virtual environment.

At step 230, parameters associated with one or more objects in the virtual environment may be modified based on the characteristic of a profile during an interaction with a user. If more than one profiles are received, the system may allow the user to select one of the profiles to be used for subsequent analysis or for modification of an object. The modification may include modifying a voiceprint of a non-playable character (NPC) based on the analyzed voice characteristics in the media file. Such modification may use deepfake techniques whereby artificial intelligence and machine learning are used to generate modified audiovisual content to have certain characteristics that align to a user or their preferences (e.g., as indicated by a profile). For example, an NPC voice may be modified to mirror the user's own voice or the voice of a user's friend, favorite celebrity, favorite movie character, etc., in accordance with the profile. Such mirroring may include not only voice characteristics, but also manner of speech including pacing, rhythm, accents, slang usage, sentence structure, and other vocal/speech habits.

When the NPC speaks to the user or an avatar of the user, the default voice may be replaced by a selected voice profile from the received media file. Such modification may include generating a vocal waveform based on the parameters of acoustic features determined during step 220. Such vocal waveform may be generated by receiving an audio file, transcribing the audio file into text, training a text to speech model, extracting parameters of speech based on the linguistic features of the voice, and creating vocal waveforms based on the parameters such that the NPC can speak based on a new text that is not found in the received media file. Alternatively, the modification to the voice of an NPC may include simply altering the parameters of the default voice rather than generating a new vocal waveform. The alteration may be achieved by receiving a spoken signal in the media file, such as the NPC speaking in a default voice and altering the signal by changing the parameters of the voice, such as style, intonation, or prosody, consistent with a selected voice profile.

In addition, the modified voice of the NPC may be used to provide an in-game tutorial for the current in-game scene. In one embodiment, one or more NPCs may provide default in-game tutorial, of which the voice of the NPC may be modified to a selected voiceprint. In other embodiments, the in-game tutorial may be provided when there is an evidence of user frustration, indicated by halted progress in the story mode, inability to clear a stage, failure to score enough points, facing repeated defeats, repeated incorrect button inputs (or other type of user input), or sensor input indicative of negative emotions expressed by the user. Moreover, during the in-game tutorial, the button input sequence of a well-known user received in the activity file may be displayed to the user. Further, the button input sequence of the well-known user or default button input sequence may be automatically compared in real-time to button input sequence of a user currently engaged in the same in-game activity in the virtual environment to indicate the differences in the button input of the user. The differences in the button input of the user from the well-known user or the default button input sequence may be highlighted or marked. The tutorial may provide the mapped button input sequences synchronized with voice-based instructions in the selected voice characteristics.

In another embodiment, the appearance of the NPC may be modified based on the analyzed visual characteristics in the received media file. Such image modification may be provided concurrently with the modification to the voice of the NPC using similar (e.g., AI-based, deepfake) techniques. Similar to the voice modification, the image modifications may be applied to the current interactive session for rendering and display in place of the original audiovisual content (e.g., original image, original voice).

In another embodiment, the background or the ambient music of the in-game scene may be modified based on the identified characteristics of the music profile. The analyzed characteristics in the received audio file may be compared to and/or matched with a characteristic of an in-game scene. Similar characteristics defined by synonyms may also be used to match the characteristics such that the portions or entirety of the music profile associated with a characteristic may replace the default background music to match the characteristics of the current in-game scenery. The modification may be automatic or based on a selection of music profiles.

FIG. 3 illustrates a block diagram of an exemplary electronic entertainment system 300 that may be used to implement embodiments of the present invention. The electronic entertainment system 300 as illustrated in FIG. 3 may correspond to console 110 of FIG. 1 and may include a main memory 302, a central processing unit (CPU) 304, graphic processor 306, an input/output (I/O) processor 308, a controller input interface 310, a hard disc drive or other storage component 312 (which may be removable), a communication network interface 314, a virtual reality interface 316, sound engine 318, and optical disc/media controls 320. Each of the foregoing are connected via one or more system buses 322.

Electronic entertainment system 300 as shown in FIG. 3 may be an electronic game console. The electronic entertainment system 300 may alternatively be implemented as a general-purpose computer, a set-top box, a hand-held game device, a tablet computing device, or a mobile computing device or phone. Electronic entertainment systems may contain some or all of the disclosed components depending on a particular form factor, purpose, or design.

Main memory 302 stores instructions and data for execution by CPU 304. Main memory 302 can store executable code when the electronic entertainment system 300 is in operation. Main memory 302 of FIG. 3 may communicate with CPU 304 via a dedicated bus. Main memory 302 may provide pre-stored programs in addition to programs transferred through the I/O processor 308 from hard disc drive/storage component 312, a DVD or other optical disc (not shown) using the optical disc/media controls 320, or as might be downloaded via communication network interface 314.

The graphics processor 306 of FIG. 3 (or graphics card) executes graphics instructions received from the CPU 304 to produce images for display on a display device (not shown). The graphics processor 306 of FIG. 3 may transform objects from three-dimensional coordinates to two-dimensional coordinates, and vice versa. Graphics processor 306 may use ray tracing to aid in the rendering of light and shadows in a game scene by simulating and tracking individual rays of light produced by a source. Graphics processor 306 may utilize fast boot and load times, 4K-8K resolution, and up to 120 FPS with 120 hz refresh rates. Graphics processor 306 may render or otherwise process images differently for a specific display device.

I/O processor 308 of FIG. 3 may also allow for the exchange of content over a wireless or other communications network (e.g., IEEE 802.x inclusive of Wi-Fi and Ethernet, 3G, 4G, LTE, and 3G mobile networks, and Bluetooth and short-range personal area networks). The I/O processor 308 of FIG. 3 primarily controls data exchanges between the various devices of the electronic entertainment system 300 including the CPU 304, the graphics processor 306, controller interface 310, hard disc drive/storage component 312, communication network interface 314, virtual reality interface 316, sound engine 318, and optical disc/media controls 320.

A user of the electronic entertainment system 300 of FIG. 3 provides instructions via a controller device communicatively coupled to the controller interface 310 to the CPU 304. A variety of different controllers may be used to receive the instructions, including handheld and sensor-based controllers (e.g., for capturing and interpreting eye-tracking-based, voice-based, and gestural commands). For example, a controller device may include switches, buttons, accelerometers, sensors, processors, radios, display elements, etc., to receive instructions or input from the user, which may then be provided to controller interface 310 and then to CPU 304 for interpretation and execution. The instructions may further be used by the CPU 304 to control other components of electronic entertainment system 300. For example, the user may instruct the CPU 304 to store certain game information on the hard disc drive/storage component 312 or other non-transitory computer-readable storage media. A user may also instruct a character in a game to perform some specified action, which is rendered in conjunction with graphics processor 306, inclusive of audio interpreted by sound engine 318.

Hard disc drive/storage component 312 may include removable or non-removable non-volatile storage medium. Saud medium may be portable and inclusive of digital video disc, Blu-Ray, or USB coupled storage, to input and output data and code to and from the main memory 302. Software for implementing embodiments of the present invention may be stored on such a medium and input to the main memory via the hard disc drive/storage component 312. Software stored on hard disc drive/storage component 312 may also be managed by optical disk/media control 320 and/or communications network interface 314.

Communication network interface 314 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 316 allows for processing and rendering of virtual reality, augmented reality, and mixed reality data. This includes display devices such that might be partial or entirely immersive virtual environments. Virtual reality interface 316 may allow for exchange and presentation of immersive fields of view and foveated rendering in coordination with sounds processed by sound engine 318 and haptic feedback.

Sound engine 318 executes instructions to produce sound signals that are outputted to an audio device such as television speakers, controller speakers, stand-alone speakers, headphones or other head-mounted speakers. Different sets of sounds may be produced for each of the different sound output devices. This may include spatial or three-dimensional audio effects.

Optical disc/media controls 320 may be implemented with a magnetic disk drive or an optical disk drive for storing, managing, and controlling data and instructions for use by CPU 304. Optical disc/media controls 320 may be inclusive of system software (an operating system) for implementing embodiments of the present invention. That system may facilitate loading software into main memory 302.

FIG. 4 illustrates a block diagram of an exemplary server 400 configured to perform a method for modifying in-game experiences or interactions for a particular user. Server 400 may be remote from console 110 (and/or entertainment system 300), but may be in communication via communication network 130 to provide various data and services in support of various activities during interactive and gameplay sessions. As provided herein, server 400 may execute applicable instructions to modify in-game experiences or interactions provided to the user device. Such modifications may be based on in-game audiovisual content and may be presented in place of or overlaid on the unmodified content. As illustrated, server 400 may include a processor 410, an interconnecting bus 420, a memory 430 (including operating system 440, database(s) 450, and interactive control process/service 460), and network interface 470.

Processor 410—which may be similar to CPU 304 of FIG. 3—may include necessary elements or logic adapted to execute the software programs and manipulate data structures in memory 430 (including from database 450 in memory 430). For example, processor 410 can include one or more programmable processors, e.g., microprocessors or microcontrollers, or fixed-logic processors. In the case of a programmable processor, any associated memory, e.g., memory 430, may be any type of tangible processor readable memory, e.g., random access, read-only, etc., that is encoded with or stores instructions that can implement program modules, e.g., a module having interactive control process/service 460 encoded thereon. Processor 410 can also include a fixed-logic processing device, such as an application specific integrated circuit (ASIC) or a digital signal processor that is configured with firmware including instructions or logic that can cause the processor to perform the functions described herein. Thus, program modules may be encoded in one or more tangible computer readable storage media for execution, such as with fixed logic or programmable logic, e.g., software/computer instructions executed by a processor, and any processor may be a programmable processor, programmable digital logic, e.g., field programmable gate array, or an ASIC that includes fixed digital logic, or a combination thereof. In general, any process logic may be embodied in a processor or computer readable medium that is encoded with instructions for execution by the processor that, when executed by the processor, are operable to cause the processor to perform the functions described herein. Interconnecting bus 420 may correspond to bus 322 of FIG. 3 and allow for various components of server 400 to communicate and exchange data.

Memory 430 may include a plurality of storage devices having locations addressable by processor 410 for storing software programs and data structures associated with the embodiments described herein. As illustrated, memory 430 may include operating system 440, database(s) 450, and interactive control process/service 460.

An operating system 440, portions of which are typically resident in memory 430 and executed by processor 410, functionally organizes the device by, inter alia, invoking operations in support of software processes and/or services executing on the device.

The databases 450 may be stored on the same server 400 or on multiple different servers 400, or on any of the user devices (e.g., console 110 or entertainment system 300) that may be used to implement any part of the NPC customization. Databases 450 may store game and other media, information regarding the specific game or content title (e.g., game characters including NPCs, game objectives, requirements, rules, dialogues, scripts, in-game actions and behaviors), historical gameplay or interactive data (e.g., object files or activity files), associated metadata, user profiles, trained learning models, past custom NPCs, and associated customization data. Each interactive title may include depictions of one or more objects (e.g., avatars, characters, activities, etc.) that a user can interactive with and/or UGC (e.g., screen shots, videos, commentary, mashups, etc.) created by peers, publishers of the content titles and/or publishers. Such data may include metadata by which to label subsets for supervised and unsupervised learning techniques. Similarly, one or more user profiles may also be stored in the databases 450. Each user profile may include information about the user (e.g., user progress in an activity and/or media content title, user id, user game characters, etc.) and may be associated with one or more media titles and engagement thereof. Such data in databases 450 may be continually updated as a user continues to engage in new sessions and produce new session data regarding various interactions that have taken place therein. The updated user data may be incorporated into or otherwise used to train a learning model to refine and make better and more nuanced predictions for the specific user.

Software processes and/or services provided by server 400 may include execution of one or more interactive control process(es)/service(s) 460. Note that while interactive control process/service 460 is shown in centralized memory 430, it may be configured to operate in a distributed network of multiple servers 400 and/or other devices. An exemplary service that may include tailoring or customization of NPC interactions to a specific user across one or more different interactive content titles. For example, speech patterns or behavioral patterns of the user may be used to modify NPC dialogue and actions to enhance immersion, comfort, interest, excitement, joy, and/or other types of engagement factors of the user experience.

Network interface(s) 470 contain mechanical, electrical, and signaling circuitry for communicating data between devices over a network such as communication network 130. Network interface 170 may communicate with such devices as user devices (e.g., console 110 or entertainment system 300), remote database, other servers 400, etc. Network interface 470 may include hardware and associated software for communicating with each of the remote devices. Such data communicated to and from network interface 470 may include user data, game data (including user commands, sensor-detected movement, verbalization, or gestures) and may also be configured to provide session data and feedback (e.g., tactile, visual, audio, etc.).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

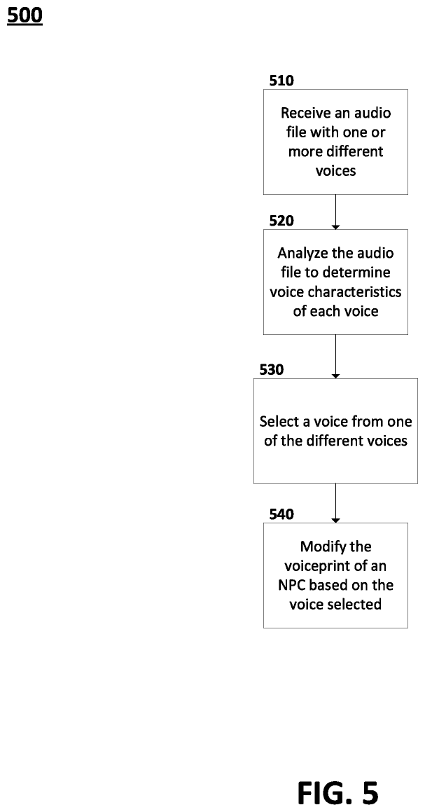

FIG. 5 is a flowchart illustrating an exemplary method 500 for modifying gameplay experiences related to voice. In Step 510, the system 100, console 110, system 300, or system 400 may receive an audio file with one or more different voices. The audio files may have been recorded (e.g., by a user device with a microphone) during a gameplay session or other type of interactive session in which at least one user is speaking or otherwise verbalizing. Some audio files may be associated with pre-existing content, such as pre-recorded audio or audiovisual (e.g., video) files or streams hosted by content hosting servers and services accessible over a communication network.

In Step 520, the one or more audio files may be analyzed to determine one or more characteristics associated with each of the voices. Such analyses may include identifying the distinct voices in the audio file, as well as the characteristics of each voice. A voice profile may be generated for each distinct voice identified as speaking in the audio file. Different voice characteristics (e.g., pitch, loudness, rate, rhythm, tone, pronunciation) may also be identified and categorized or measured for each identified voice. The resulting voice profile may also track parameters of each of the voice characteristics.

In Step 530, a user may select or indicate a preferred voice from among one or more different types of voices. Such selection may be made using a menu of options presented within a graphical user interface or otherwise indicated by the user (e.g., signs of frustration with a current voice, engagement with a particular player or NPC with different voice characteristics). In some implementations, a recommendation may be suggested or automatically selected for the user (e.g., based on a user profile or user data).

In Step 540, a voice profile or voiceprint of an NPC may be modified based on the voice profile (e.g., including parameters relating to different voice characteristics) of the selected voice during an interaction between the NPC and the user or an avatar of the user. For example, the pitch of the NPC voice may be modified to match the pitch parameters of the selected voice profile, while a tone of the NPC voice may remain the same, and a pace of the NPC voice may be slowed down. Once such modifications are applied to the NPC voice, subsequent interactions between the player and the NPC that involve NPC speech may include use of the modified voice by the NPC. Such modifications may further evolve over time as the user changes or evolves in their preferences (e.g., a child growing up and developing different tastes). As such, an NPC that has had its voice modified to sound more child-like and to speak more simply while the user is a child may later have its voice further modified to sound older and to be able to converse using more complex language.

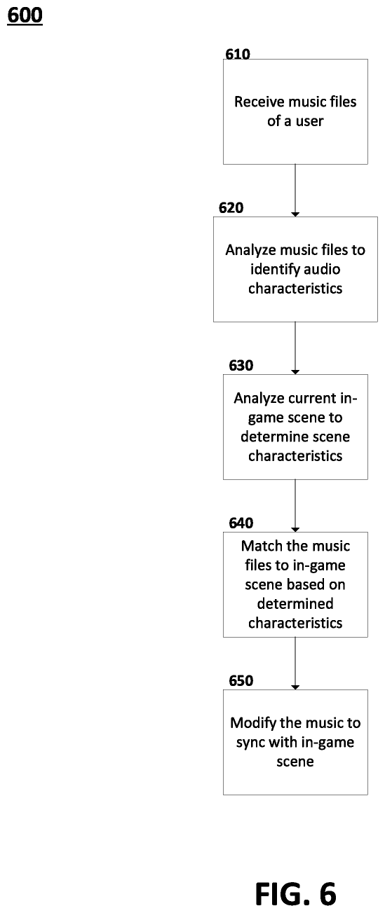

FIG. 6 is a flowchart illustrating an exemplary method for modifying gameplay experiences related to sound or music. In Step 610, one or more music files that include different profiles of music are received. The music files may be received from the system 100, console 110, system 300, system 400, a database stored in any of the systems, or a playlist via a network. The music files or playlist may be specific to the user and maintained or hosted by servers or service providers that are accessible for streaming the content files. In some implementations, audio files may be recorded and provided to the computing device.

In step 620, the music profiles may be analyzed to identify the characteristics of the music profile by comparing the parameters of the music profile to parameters of known characteristics of music. In some implementations, pre-existing music profiles may be accessible from a library or other database regarding the music files. The music characteristics of the audio file may be identified and profiled (e.g., measured or otherwise classified) to identify musical styles, genres, rhythms, time signatures, instruments and instrumentation, vocals and vocal styles, mood, lyrics, and other characteristics or descriptors of the sounds or music.

In Step 630, the characteristics of a current in-game scene may be identified based on various game parameters of an in-game scene, such as movement of the in-game objects, lighting, color, in-game level and location, in-game progress such as clearing a stage, presence or appearance of certain in-game characters or objects, tone of an in-game dialogue, or any metadata associated with defining the in-game scene, in-game actions, etc., may contribute to characterization of the in-game scene. Such game or activity data may be captured and recorded in activity files that are stored in a database in memory. In some implementations, activity models may be constructed from historical activity files (e.g., associated with the user or with other users) to characterize gameplay and to identify gameplay patterns indicative of certain gameplay trajectories and outcomes. Such activity models may also be used to predict the likely trajectory of a current gameplay session and events likely to occur therein. For example, the activity model may be used by the computing device to predict that players that take a particular route along a race or that use a particular weapon in a fight against an opponent are likely to face certain upcoming obstacles in the game environment or moves by the opponent within the gameplay session.

In Step 640, the characteristics of the music profiles may be compared and matched with the characteristics of the activity in the current in-game scene to determine whether the music or sound fits the mood or action within the scene. For example, a loud, up-tempo song may be determined to fit the pacing of a climactic racing scene, while that same song may be distracting or jarring when played in portions of an activity that may require stealth, concentration, or quiet communication. Conversely, slow ballads (e.g., that may make a player sleepy or otherwise slow down their reflexes) may be found to be unsuitable for intense fighting sequences or other battle sequences. The suitability association between music/sounds and gameplay/interactive activity (and portions thereof) may be modeled and refined over multiple sessions in which users provide express or implicit (e.g., behavioral) feedback as to the suitability of the music/sound over the course of the gameplay session.

In Step 650, the music of the in-game scene is modified for the user. Such modifications may be based on the user's favorite music or existing playlists, as well as based on matching identified characteristics of the music profile and current game or interactive activity. The music of the game may be changed from default music to one or more portions of the audio file (or a different audio file) that match or is similar to the characteristic of the in-game scene. The modified music may be played and synchronized to the predicted trajectory and event(s) for the in-game scene.

The musical modifications may include not only the music/song (or respective portion) selection, but also modifying the audio file itself to change characteristics of the music/song, including pitch, rhythm, instrumentation, vocals (e.g., addition, modification or removal), genre, etc., to fit the characteristics of the current activity or scene. Different sections of songs or playlists may be modified and synchronized in real-time based on actions and interactions currently occurring or being displayed in a particular interactive scene. For example, one song may be selected based on a pace at which a character may be running, and song play may stop, switch to another song, or otherwise modified based on the character slowing down or stopping, speeding up, turning in a different direction, passing through different game environments or by different characters, and other in-game events.

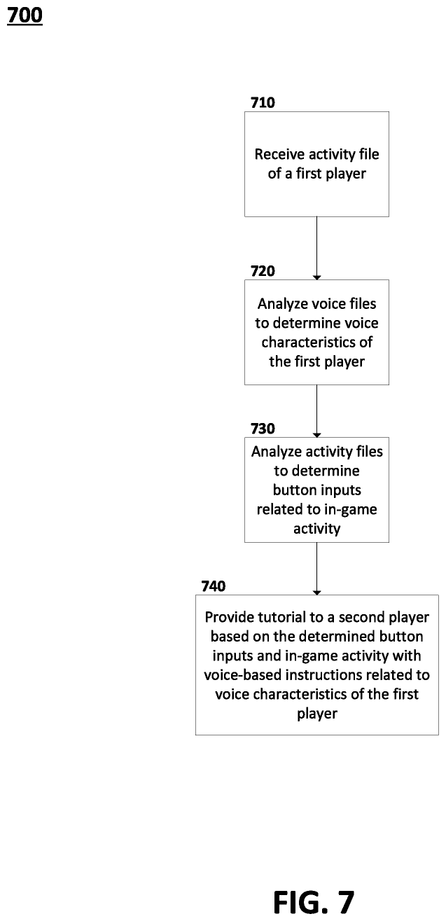

FIG. 7 is a flowchart illustrating an exemplary method for modifying gameplay experiences related to game tutorial content. Current gameplay may be analyzed to identify relevant game tutorial content, which may be selected and presented to the player in real-time to assist with player progression within an interactive session. Such game tutorial content may be generated based on predetermined famous celebrity players, expert players, or otherwise successful players.

In Step 710, the activity files of a first player may be received. The first player may be a peer of the user, a favorite character with known voice profile, or a famous player whose voice files and activity files may be searchable over a network. The activity files for the first play may include game data collected during different gameplay sessions, game results, game activity, game actions and behaviors, sequence of button or other user gameplay inputs, and any other actions taken and observed of the first player during a game or other interactive session. Such activity files may be analyzed to identify current in-game activity or other activity taking place in a virtual environment of a current interactive session. Such analyses may be similar to those described in relation to step 630 of FIG. 6

In Step 720, the voice files of the first player may also analyzed to determine voice characteristics of the first player. Such analyses may be similar to that described in relation to step 520 of FIG. 5.

In Step 730, the activity file of the first player may be further analyzed to map the sequence of button inputs (or other type of game input or interactive input) of the first player to an in-game activity. In Step 740, a tutorial may be provided to a second user, such as user 105, in which the tutorial includes mapped sequences of button inputs of the first player to the in-game activity currently engaged by the second player. Providing the tutorial may involve modifying a voiceprint of an NPC based on the voice characteristic of the first player. The tutorial may include real-time automated comparison of the sequence of button inputs between the first player and the second player. The tutorial content may be presented by pausing a current session or may be presented in synchronization with the current session. For example, the tutorial content may be include an overlay, other display on the same or different associated screen (e.g., user mobile device), audio content only, or other combination whereby gameplay advice and guidance is presented in real-time as the user is determined to deviate from the predetermined button inputs (or other inputs) associated with successful gameplay sequences.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method of providing a customized virtual experience, the method comprising:
storing one or more media files in memory, wherein the media files include one or more different content profiles;
monitoring a current interactive session with a user device of a user, wherein the current interactive session includes current activity within a virtual environment;
identifying that a user of the user device is associated with a user profile that includes a specified type of content customization corresponding to at least one of the content profiles;
identifying that one or more characteristics associated with the at least one content profile corresponds to the current activity within the virtual environment; and
modifying one or more parameters of the virtual environment presented during the current interactive session based on a waveform associated with a characteristic of the at least one content profile.

2. The method of claim 1, wherein the media files include sensor data from one or more sensors.

3. The method of claim 2, wherein the data from the sensors includes audio files.

4. The method of claim 1, wherein the media files include music files from a database.

5. The method of claim 1, wherein the media files include activity files recorded during a past interactive session with a player device of a player, wherein the activity files include a sequence of user inputs received by the player device of the player.

6. The method of claim 1, further comprising analyzing the media files to determine the one or more characteristics associated with the content profiles.

7. The method of claim 1, further comprising analyzing an in-game scene within the current virtual environment to identify a characteristic of the in-game scene.

8. The method of claim 7, further comprising comparing the characteristics specified by the at least one content profile regarding one or more portions of the media file to the characteristic of the in-game scene.

9. The method of claim 8, wherein modifying the parameters of the virtual environment includes modifying sound or music of the in-game scene based on the characteristic of one of the portions of the media file and the identified characteristics of the in-game scene.

10. The method of claim 1, wherein modifying the parameters of the virtual environment includes modifying an appearance of a non-playable character or virtual object based on visual characteristics received in the at least one content profile.

11. The method of claim 1, wherein modifying the parameters of the virtual environment includes modifying a voice of a non-playable character during the current interactive session.

12. The method of claim 11, wherein modifying the voice of the non-playable character is based on the waveform included in the characteristics of the at least one content profile.

13. The method of claim 1, further comprising generating custom tutorial content based on the identified characteristics of the profile, wherein modifying the parameters of the virtual environment includes presenting the custom tutorial content in association with the virtual environment.

14. The method of claim 13, wherein the tutorial content includes an illustration of a mapped sequence of button inputs synchronized with voice-based instruction synchronized to one or more actions in the virtual environment.

15. The method of claim 13, wherein the tutorial content includes an illustration of a real-time automated comparison of a sequence of button inputs from the user and from a different user.

16. The method of claim 1, further comprising receiving a user selection of the user profile from the one or more user profiles each associated with a different type of content customization.

17. A system for providing a customized in-game experience, the system comprising:
memory that stores one or more media files, wherein the media files include one or more different content profiles;
a communication interface that receives monitoring data sent over a communication network regarding a current interactive session with a user device of a user, wherein the current interactive session includes current activity within a virtual environment; and
a processor that executes instructions stored in memory, wherein the processor executes the instructions to:
identify that a user of the user device is associated with a user profile that includes a specified type of content customization corresponding to at least one of the content profiles;
identify that one or more characteristics associated with the at least one content profile corresponds to the current activity within the virtual environment; and
modify one or more parameters of the virtual environment presented during the current interactive session based on a waveform associated with a characteristic of the at least one content profile.

18. The system of claim 17, further comprising one or more sensors, wherein the received media files include data from the sensors.

19. A non-transitory computer-readable storage medium, having embodied thereon a program executable by a processor to perform a method for providing a customized in-game experience, the method comprising:
storing one or more media files in memory, wherein the media files include one or more different content profiles;
monitoring a current interactive session with a user device of a user, wherein the current interactive session includes current activity within a virtual environment;
identifying that a user of the user device is associated with a user profile that includes a specified type of content customization corresponding to at least one of the content profiles;
identifying that one or more characteristics associated with the at least one content profile corresponds to the current activity within the virtual environment; and
modifying one or more parameters of the virtual environment presented during the current interactive session based on a waveform associated with a characteristic of the at least one content profile.
